(19) United States
(12) Patent Application Publication
(10) Pub. No.: US 2010/0097347 A1
(43) Pub. Date: Apr. 22, 2010

(54) Pressure Detection Module, and Touch Panel with Pressure Detection Module

(76) Inventor: Tzu-Chih Lin, Hsinchu City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/573,926

(22) Filed: Oct. 6, 2009

(30) Foreign Application Priority Data
Oct. 21, 2008 (TW) 097140367

(51) Int. Cl. G06F 3/045

(52) U.S. Cl. 345/174

(57) ABSTRACT

A touch panel is installed in an electronic device. The touch panel comprises a display module and a plurality of pressure detection modules. The display module is electrically located in the electronic device. The plurality of pressure detection modules are electrically coupled to the electronic device, and each of them contacts the bottom of the display module. Each pressure detection module can transmit corresponding different signals to the electronic device according to different pressures, so as to calculate a pressed position of the display module according to the corresponding different pressures sensed by the pressure detection modules.

### BACKGROUND OF THE INVENTION

1. Field of the Invention

The present invention relates to a pressure detection module and a touch panel with a pressure detection module.

2. Description of the Related Art

In the prior arts, portable electronic devices with touch panels (such as digital cameras) have been available. There are two categories of prior art touch panels: resistive touch panels and capacitive touch panels, classified according to the physical principles of the detection of the touching position. Both resistive and capacitive touch panels need to have a glass plate with conductive coating paint, and the size of the glass plate is equal to the size of the screen. Resistive touch panels employ the pressure of a finger or a stylus, etc., to generate voltage; for capacitive touch panels, a little electric current can be drawn by a finger so as to obtain the position of a point on the touch panel being pressed by the detection of variation in voltage or current value. However, due to the high cost, it is difficult to apply them to all electronic devices.

Therefore, it is desirable to provide new technology to mitigate and/or obviate the aforementioned disadvantage.

### SUMMARY OF THE INVENTION

An objective of the present invention is to provide a pressure detection module and a touch panel with a pressure detection module, so as to calculate a pressed position of the display module according to the pressures sensed by the pressure detection modules.

Another objective of the present invention is to provide a pressure detection module with touch detection capability at lower cost and a touch panel with the pressure detection module.

An additional objective is to provide a pressure detection module which can be conveniently installed in an electronic device and a touch panel with the pressure detection module.

In order to achieve the above-mentioned objectives, the portable electronic device of the present invention has a touch panel. The touch panel comprises a display module and a plurality of pressure detection modules. The display module is electrically located in the electronic device. The plurality of pressure detection modules are disposed in and electrically coupled to the electronic device, and each of them contacts the bottom surface of the display module. Each pressure detection module can transmit corresponding different electrical signals according to different pressures, so as to calculate a pressed position of the display module according to the corresponding different pressures sensed by the pressure detection modules.

Each pressure detection module comprises a casing, an action element, an elastic electric member, a resistance member, and a conductive member in accordance with one embodiment of the present invention. The outside bottom surface of the casing is fixed to the electronic device, and its outside top surface is close to the bottom surface of the display module and has a hole. The action element comprises a slab with a side removably in the casing and a protrusion which is located on the top surface of the slab, passes through the hole to be against the bottom surface of the display module. The elastic electric member comprises a fringe rod connected to the slab and a rebounding portion which is formed by bending the end of the fringe rod and is against the inside bottom surface of the casing. The resistance member is disposed within a side of the casing and touches the fringe rod of the elastic electric member. When the protrusion is pressed to make the slab descend, which produces a position of the resistance member being touched by the fringe rod, so as to make the resistance member perform a corresponding resistance value in association with the movement of the slab. In addition, the conductive member is disposed within a side of the casing different from the side where the resistance member is located and touches the fringe rod of the elastic electric member.

### BRIEF DESCRIPTION OF THE DRAWINGS

FIG. 1 is a schematic drawing of an electronic device applying the present invention.

FIG. 2 is a schematic drawing of a touch panel of the present invention.

FIG. 3 is an exploded view of an embodiment of a pressure detection module of the present invention.

FIG. 4 is an exploded view of an embodiment of the pressure detection module of the present invention from another angle.

FIG. 5 is a schematic drawing of an embodiment of the pressure detection module of the present invention when the action element is not pressed.

FIG. 6 is a schematic drawing of an embodiment of the pressure detection module of the present invention when the action element is pressed.

### DETAILED DESCRIPTION OF THE PREFERRED EMBODIMENT

The advantages and innovative features of the invention will become more apparent from the following detailed description when taken in conjunction with the accompanying drawings.

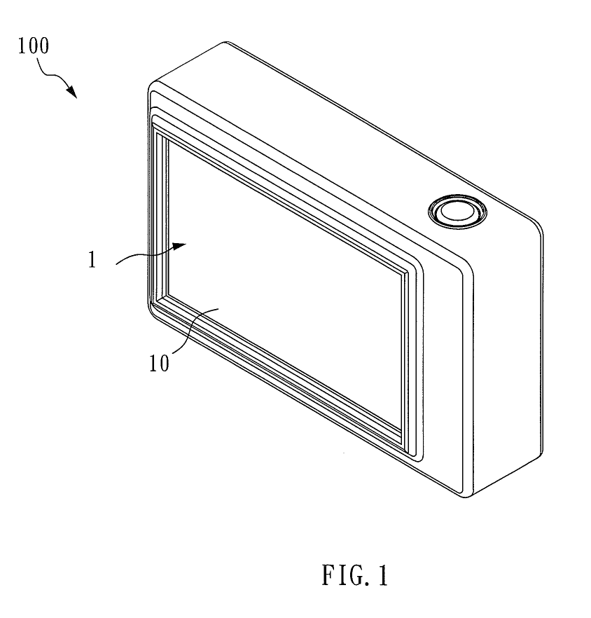

Please refer to FIG. 1, a schematic drawing of an electronic device applying the present invention. An electronic device 100 comprises a touch panel 1, which allows a user to press it and determines the position of being pressed. For example, the user can press a display module 10 of the touch panel 1 to click an icon displayed by the display module 10. In this embodiment, the electronic device 100 is a digital camera, but the electronic device 100 can also be other devices with the touch panel 1, such as a mobile phone or a PDA.

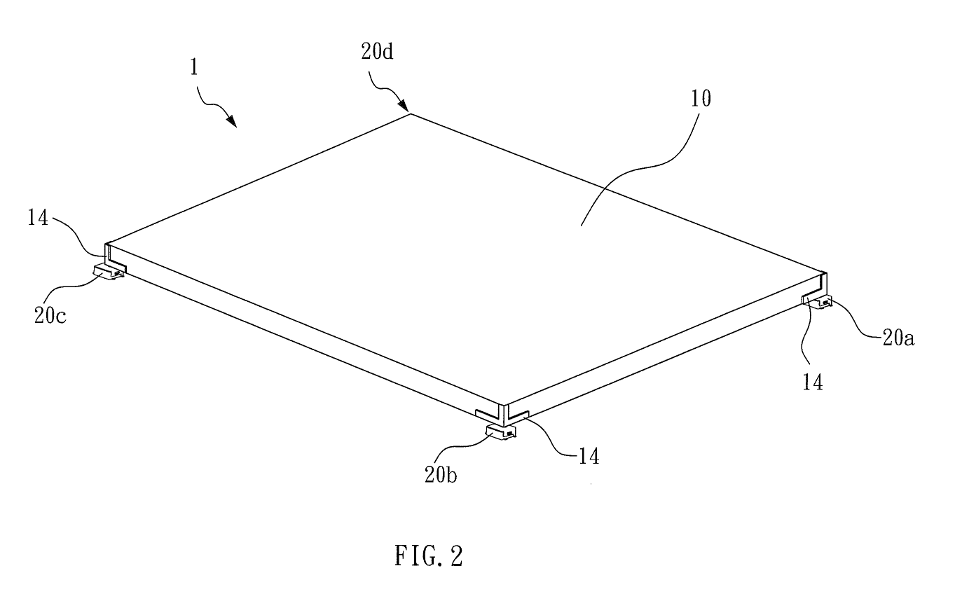

Next, please refer to FIG. 2, a schematic drawing of a touch panel of the present invention. The touch panel 1 mainly comprises the display module 10 and pressure detection modules 20a, 20b, 20c, and 20d.

The display module 10 is electrically located in the electronic device 100 for displaying images. The user can obtain various types of information and carry out various operations via the display module 10.

The pressure detection modules 20a, 20b, 20c, and 20d are disposed in and electrically coupled to the electronic device 100. Each of them contacts the bottom surface of the display module 10. Each pressure detection module 20a, 20b, 20c, or 20d can transmit corresponding different electrical signals according to different pressures, so as to calculate a pressed position of the display module 10 according to the corresponding different pressures sensed by the pressure detection modules.

The pressure detection modules 20a, 20b, 20c, and 20d are located in the inside corners of the display module 10, and the pressure detection modules 20a, 20b, 20c, and 20d directly contact the display module 10. In this embodiment, the display module 10 is a quadrilateral, so there are four pressure detection modules 20a, 20b, 20c, and 20d located in the four corners of the display module 10.

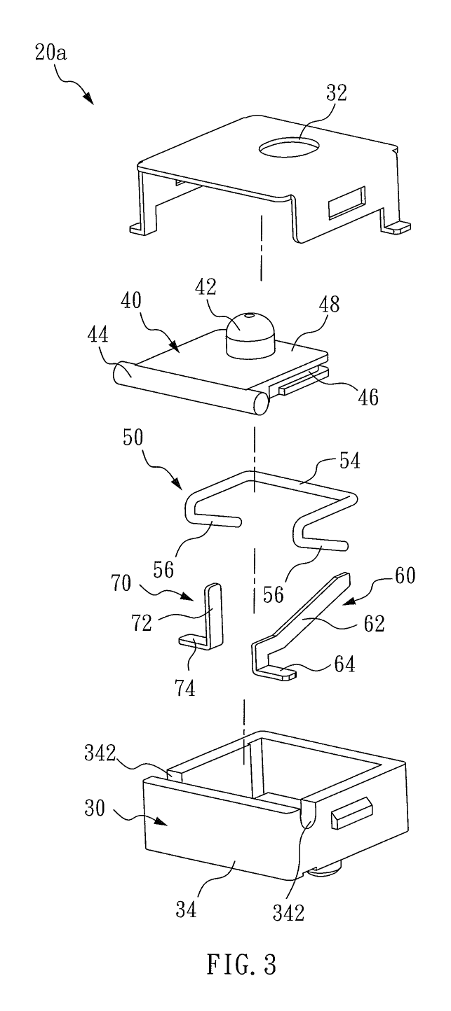

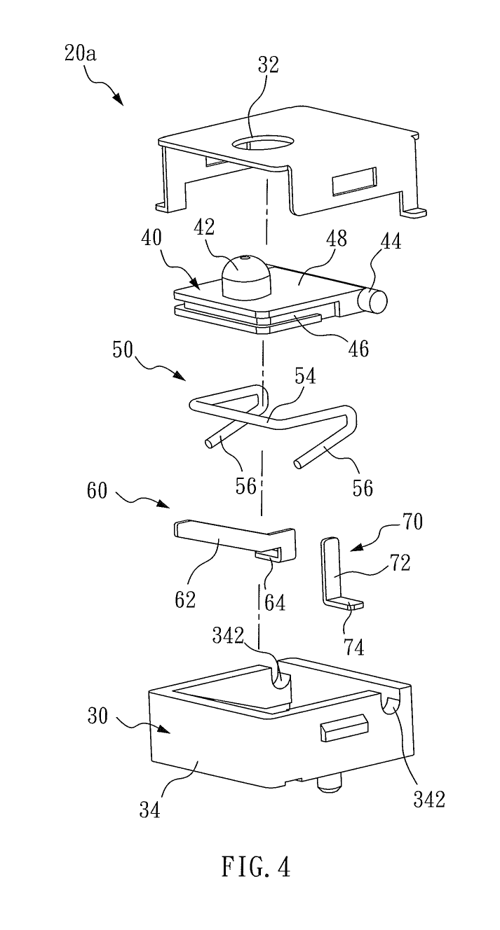

Please refer to FIG. 3 and FIG. 4. FIG. 3 is an exploded view of an embodiment of a pressure detection module of the present invention. FIG. 4 is an exploded view of an embodiment of a pressure detection module of the present invention from another angle. Each pressure detection module 20a, 20b, 20c, or 20d comprises a casing 30, an action element 40, an elastic electric member 50, a resistance member 60, and a conductive member 70.

The action element 40, the elastic electric member 50, the resistance member 60, and the conductive member 70 are held in the casing 30. The outside bottom surface of the casing 30 is fixed to the electronic device, and its outside top surface is close to the bottom surface of the display module 10 and has a hole 32.

The action element 40 can move downward a certain distance when force acts upon it. The distance is in direct portion to the force. The source of the force can be, for example, the user's finger. In this embodiment, the action element 40 comprises a slab 48 with a side removably in the casing 30 and a protrusion 42 which is located on the top surface of the slab 48, passes through the hole 32 to be against the bottom surface of the display module 10. The protrusion 42 directly contacts the corners of the display module 10 (as shown in FIG. 2). When the display module 10 is pressed, the protrusion 42 is also pressed. The force acting upon the protrusion 42 is directly passed to the elastic electric member 50 connected with the protrusion 42.

In this embodiment, the display module 10 comprises a frame 14 located in the four corners of the display module 10. The protrusion 42 of the action element 40 directly contacts the frame 14. The function of the frame 14 is to strengthen the structure of the edge of the display module 10. It should be noted that the frame 14 can also surround the display module 10.

In order to allow the protrusion 42 to be pressed, in this embodiment, the action element 40 has a shaft 44 on a side, and the casing 30 has shaft holders 342 formed on its two sides opposite to each other. The shape and position of the shaft 44 and that of the shaft holders 342 match up so as to enable the two ends of the shaft 44 to pivot the shaft holders 342 respectively. Therefore, when the protrusion 42 is pressed, the action element 40 can pivot the shaft 44.

The elastic electric member 50 is connected with the action element 40. The elastic electric member 50 comprises a fringe rod 54 connected to the slab 48 and a rebounding portion 56 which is formed by bending the end of the fringe rod 54 and is against the inside bottom surface of the casing 30. When the protrusion 42 is pressed, the elastic electric member 50 is compressed; when the protrusion 42 is not pressed, the elastic electric member 50 will return to its original state. In this embodiment, a joint groove 46 is formed on three lateral surfaces of the action element for connecting the elastic electric member 50 with the action element 40. The fringe rod 54 of the elastic electric member 50 is a U-shaped metal rod that infixes the joint groove 46. It should be noted that the form of the connection between the elastic electric member 50 and the action element 40 of the present invention is not limited by this description.

The resistance member 60 is disposed within a side of the casing 30 and touches the fringe rod 54 of the elastic electric member 50. When the protrusion 42 is pressed to make the slab 48 descend, which produces a position of the resistance member 60 being touched by the fringe rod 54, so as to make the resistance member 60 perform a corresponding resistance value in association with the movement of the slab 48.

In this embodiment, the resistance member 60 comprises a metal board 62 located on the inside surface of the casing 30 at an angle and a conductive leg 64 which is formed by bending the end of the metal board 62 and passes through the casing 30. The purpose of the oblique resistance member 60 is to increase the length of the resistance member 60 so as to increase the range in which the elastic electric member 50 can move along the resistance member 60, which can reduce the errors in the resistance value of the resistance member 60.

The conductive member 70 is disposed within a side of the casing 30 different from the side on which the resistance member 60 is located. The conductive member 70 touches the fringe rod 54 of the elastic electric member 50 such that the conductive member 70, the elastic electric member 50, and the resistance member 60 are electrically conductive. In this embodiment, the conductive member 70 comprises a metal board 72 located on the inside surface of the casing 30 perpendicularly and a conductive leg 74 that is formed by bending the end of the metal board 72 and passes through the casing 30.

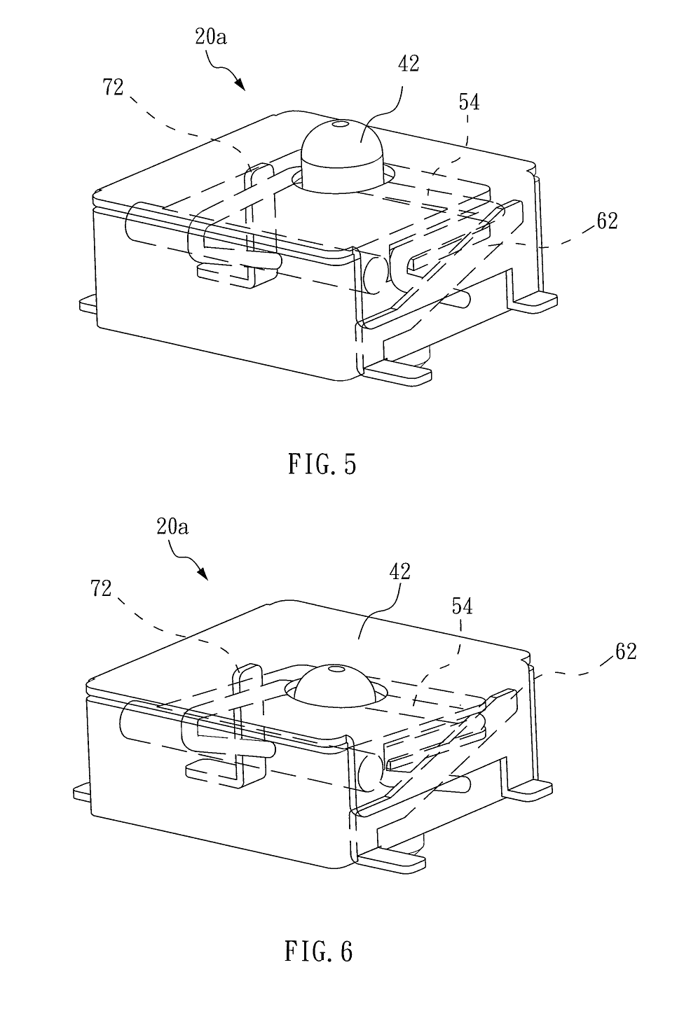

Next, please refer to FIG. 5 and FIG. 6 for the illustration of the operation of the pressure detection modules 20a, 20b, 20c, and 20d. FIG. 5 is a schematic drawing of an embodiment of the pressure detection module of the present invention when the action element is not pressed. FIG. 6 is a schematic drawing of an embodiment of the pressure detection module of the present invention when the action element is pressed.

When the display module 10 is not pressed, which indicates that the protrusion 42 is not pressed (as shown in FIG. 5), the fringe rod 54 of the elastic electric member 50 maintains contact with the upper portion of the resistance member 60. This allows electrical signals to flow through a longer path along the resistance member 60, thereby generating a larger resistance value.

When the user presses the display module 10, the protrusion 42 is also pressed (Please refer to FIG. 6.); this pressure changes the touching position of the fringe rod 54 of the elastic electric member 50 and the resistance member 60. More specifically, the fringe rod 54 of the elastic electric member 50 touches the upper portion of the resistance member 60. This allows electrical signals to flow through a shorter path along the resistance member 60, thereby generating a smaller resistance value.

The following illustrates how the position of a point on the display module 10 being pressed is obtained. Please refer to FIG. 2, FIG. 5 and FIG. 6. If the linear deformation caused by pressure of the pressure detection module 20a is greater than the linear deformation of the pressure detection module 20b, it can be known that the position being pressed by the user is closer to the pressure detection module 20a of the display module 10 shown in FIG. 2 (i.e., the top portion of FIG. 2). The greater difference in the deformation indicates that the position to which pressure is being applied is closer to the top portion of the display module 10; if the linear deformation of the pressure detection module 20c is greater than the linear deformation of the pressure detection module 20b, it can be known that the position being pressed by the user is closer to the pressure detection module 20c of the display module 10 shown in FIG. 2 (i.e., the left portion of FIG. 2). The greater difference in the deformation indicates that the position being pressed is closer to the left portion of the display module 10. Each resistance value obtained depends on each linear deformation of the pressure detection modules 20a, 20b, 20c, and 20d. Thus, the position of a point on the display module 10 being pressed can be determined according to each particular resistance value.

It should be noted that the structure of the pressure detection module applied to the electronic device 100 of the present invention is not limited by the above description. For example, the pressure detection module can consist of piezoresistance.

Compared with resistive or capacitive touch panels with high costs in the prior arts, the pressure detection module and touch panel with a pressure detection module of the present invention can attain the result that the position being pressed can be calculated with lower costs when a point on the touch panel is pressed due to the simpler structure.

In addition, resistive or capacitive touch panels need to have conductive coating paint in a screen module, which results in a considerably complicated manufacturing process. The pressure detection module and the touch panel with a pressure detection module of the present invention simply employs pressure detection modules located in proper positions underneath the panel to provide touch detection capability. The manufacturing process of such a device is much simpler than those in the prior arts.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A touch panel installed in an electronic device, the touch panel comprising:
a display module electrically located in the electronic device; and
a plurality of pressure detection modules disposed in and electrically coupled to the electronic device, and each of the pressure detection modules contacting the bottom surface of the display module; each pressure detection module can transmit corresponding different electrical signals to the electronic device according to different pressures, so as to calculate a pressed position of the display module according to the corresponding different pressures sensed by the pressure detection modules.

2. The touch panel as claimed in claim 1, wherein each pressure detection module comprises:
a casing, wherein its outside bottom surface is fixed to the electronic device, and its outside top surface is close to the bottom surface of the display module and has a hole;
an action element comprising a slab with a side removably in the casing, and a protrusion which is located on the top surface of the slab, passes through the hole to be against the bottom surface of the display module;
an elastic electric member comprising a fringe rod connected to the slab, and a rebounding portion which is formed by bending the end of the fringe rod and is against the inside bottom surface of the casing;
a resistance member disposed within a side of the casing and touching the fringe rod of the elastic electric member; when the protrusion is pressed to make the slab descend, which produces a position of the resistance member being touched by the fringe rod, so as to make the resistance member perform a corresponding resistance value in association with the movement of the slab; and
a conductive member disposed within a side of the casing different from the side on which the resistance member is located and touching the fringe rod of the elastic electric member.

3. The touch panel as claimed in claim 2, wherein the action element has a shaft on a side; the casing has shaft holders formed on its two sides opposite to each other; the two ends of the shaft pivot the shaft holders respectively.

4. The touch panel as claimed in claim 2, wherein the resistance member comprises a metal board located on the inside surface of the casing at an angle, and a conductive leg which is formed by bending the end of the metal board and which passes through the casing.

5. The touch panel as claimed in claim 2, wherein the conductive member comprises a metal board located on the inside surface of the casing perpendicularly, and a conductive leg which is formed by bending the end of the metal board and which passes through the casing.

6. The touch panel as claimed in claim 2, wherein a joint groove is formed on three lateral surfaces of the action element, and the fringe rod of the elastic electric member is a U-shaped metal rod that infixes the joint groove.

7. The touch panel as claimed in claim 2, the display module comprising a frame contacting the protrusion.

8. The touch panel as claimed in claim 1, wherein the amount of the plurality of pressure detection modules is four, and they are respectively located in the corners of the display module.

9. The touch panel as claimed in claim 1, wherein each pressure detection module comprises a piezoresistance.

10. A pressure detection module, applied to a display module of a touch panel of an electronic device, the pressure detection module comprising:
a casing, wherein its outside bottom surface is fixed to the electronic device, and its outside top surface is close to the bottom surface of the display module and has a hole;
an action element comprising a slab with a side removably in the casing, and a protrusion which is located on the top surface of the slab, passes through the hole to be against the bottom surface of the display module;
an elastic electric member comprising a fringe rod connected to the slab, and a rebounding portion which is formed by bending the end of the fringe rod and is against the inside bottom surface of the casing;
a resistance member disposed within a side of the casing and touching the fringe rod of the elastic electric member; when the protrusion is pressed to make the slab descend, which produces a position of the resistance member being touched by the fringe rod, so as to make the resistance member perform a corresponding resistance value in association with the movement of the slab; and
a conductive member disposed within a side of the casing different from the side where the resistance member is located and touching the fringe rod of the elastic electric member.

11. The pressure detection module as claimed in claim 10, wherein the action element has a shaft on a side; the casing has shaft holders formed on its two sides opposite to each other; the two ends of the shaft pivot the shaft holders respectively.

12. The pressure detection module as claimed in claim 10, wherein a joint groove is formed on three lateral surfaces of the action element, and the fringe rod of the elastic electric member is a U-shaped metal rod that infixes the joint groove.

13. The pressure detection module as claimed in claim 10, wherein the display module comprises a frame contacting the protrusion.

14. The pressure detection module as claimed in claim 10, wherein the resistance member comprises a metal board located on the inside surface of the casing at an angle and a conductive leg which is formed by bending the end of the metal board and which passes through the casing.

15. The pressure detection module as claimed in claim 10, wherein the conductive member comprises a metal board located on the inside surface of the casing perpendicularly and a conductive leg which is formed by bending the end of the metal board and which passes through the casing.
